(19) United States
(12) Patent Application Publication
(10) Pub. No.: US 2025/0200601 A1
(43) Pub. Date: Jun. 19, 2025

(54) AR REWARD EXPERIENCE

(71) Applicant: Benjamin Capital Partners, Inc., New York, NY (US)

(72) Inventors: Jason Bender, Bee Cave, TX (US); Aubrey Kristopher Johnson, Bee Cave, TX (US)

(21) Appl. No.: 18/975,637

(22) Filed: Dec. 10, 2024

Related U.S. Application Data
(63) Continuation of application No. 63/609,763, filed on Dec. 13, 2023.
(60) Provisional application No. 63/561,703, filed on Mar. 5, 2024.

(51) Int. Cl. G06Q 30/0217; G06T 19/00

(52) U.S. Cl. CPC G06Q 30/0217; G06T 19/006

(57) ABSTRACT

An Augmented Reality (AR) Reward Experience is provided comprising an AR enabled device (cell phones, tablets, smart watches, vision goggles, etc.) for receiving a triggered reward experience from a source thereof, and for allowing an end user to locate a selected object within a viewing screen of the AR enabled device. When the selected object is located, the AR enabled device indicates a designated reward for the user. The triggered reward experience may come when the end user begins the AR Reward Experience, or alternatively, upon completion of a commercial transaction, for which An AR Reward Experience has been created.

### CROSS REFERENCE TO RELATED APPLICATION(S)

This application claims priority to U.S. Provisional application, Ser. No. 63/609,763, filed Dec. 13, 2023, and to U.S. Provisional application, Ser. No. 63/561,703, filed Mar. 5, 2024.

### BACKGROUND

### Field of the Invention

The invention described herein relates generally to the use of mobile electronic devices such as cell phones, tablets, headsets, watches, etc. utilizing augmented reality (AR) for the purpose of attracting and rewarding customers that engage in AR activities.

### Background of the Invention

Augmented reality (AR) is an interactive experience that enhances the real world with computer-generated perceptual information. Utilizing software, applications, and hardware such as AR glasses, AR overlays digital content onto real-life environments and objects. This augmentation enhances the user experience and transforms one's immediate surroundings into an interactive learning environment. Augmented Reality works by superimposing digital information onto real-world objects to create a 3D experience that allows users to interact with both the physical and digital worlds.

If you have ever utilized a street view service (e.g., Apple Maps, Google Maps, etc.) to familiarize yourself with a neighborhood prior to travel or an interior decoration application to visualize furniture placement in your living room, you have already encountered augmented reality (AR). In the entertainment industry, there are numerous examples of AR: filters that modify the visual appearance of an individual within a photograph, games that integrate real and virtual environments, and applications that position virtual characters within a physical setting.

In the current digital marketing ecosystem, engagement and retention strategies are facing significant challenges. Traditional methods, such as email, texting, and standard in-app notifications, are becoming increasingly ineffective. These methods are characterized by their repetitive and overused nature, and thus are failing to capture the attention of the target audience. Emerging technologies such as augmented reality (AR) have the potential to help marketers differentiate their campaigns, yet they remain underutilized due to high costs and technical complexity. Most AR marketing is one-time, high-cost initiatives delivering visually appealing but ephemeral campaigns focused primarily on brand awareness. These campaigns fail to offer tangible value or incentives to the end customer and thus do not contribute significantly to customer engagement or long-term brand loyalty.

This absence of customer-centric, engaging, and value-driven marketing experiences results in missed chances to establish stronger connections with consumers, which can, in turn, effectively impact consumer behavior. Addressing these challenges, our invention introduces a novel system which integrates AR into marketing strategies by providing an ‘experience as a service’. This enables marketers to engage with their audience by offering rewards (such as cash, points or even physical items) within an AR environment. Our AR reward system creates a more immersive and interactive experience for consumers, leading to better engagement and higher marketing efficiency. Our system further increases the yield of marketing spend by driving higher Return on Ad Spend (ROAS) over traditional, less engaging, mediums like social ads or email. Our invention further offers significant flexibility, empowering marketers to trigger an AR experience at any point in the customer lifecycle.

This flexibility allows marketers to tailor our AR system for specific marketing objectives, whether it be driving engagement, retention, lift, frequency, dayparting, or other specific consumer behaviors. In addition, our system provides a turnkey setup that allows marketers to create and deploy AR reward campaigns through a point-and-click interface. Our system reduces the technical and financial barriers associated with AR, making it accessible to a wider range of marketers, including those with limited resources. Deploying a campaign can be done with a low effort code integration or, in the case of some campaigns, without any integration at all.

There is currently nothing in the market that is purpose built for enabling a reward experience in AR. Furthermore, there is not anything that enables an AR experience to be configured, composed and deployed in a turn key manner, via a web interface.

### SUMMARY OF THE INVENTION

In one embodiment, the present invention provides an Augmented Reality (AR) Reward Experience system that includes an AR enabled device, a Decision Maker System, in communication with the AR enabled device, the Decision Maker System configured to create a Reward Campaign for at least one AR enabled device, an AR Trigger, in communication with the AR enabled device, for initiating an AR Reward Experience after the Reward Campaign is created, and A Reward Platform, in communication with the Decision Maker System and the AR enabled device, for communicating a Reward to the AR enabled device, wherein the AR Reward Experience system provides an engaging augmented reality for allowing a user to find and locate a virtual object using their AR enabled device, for the purpose of earning a reward.

In an alternative embodiment, the present invention provides a Marketplace system for triggering an AR enabled device, including an AR Trigger, for triggering an AR enabled device after and end user of the AR enabled device completes a commercial transaction, the AR enabled device, for receiving the trigger, and software, executing on the AR enabled device, for launching an AR Reward Experience, wherein the software provides a thru view of the world in front of the AR enabled device, presents a selected object to the end user when the AR enabled device is pointed at a preselected virtual position relative to the end user, and presents a Reward to the end user when the end user locates the selected object within the thru view, wherein the end user is engaged in the AR Reward Experience after completing the commercial transaction.

In another embodiment, the present invention provides a marketing method for engaging a user in a marketing campaign, the marketing campaign utilizing an Augmented Reality (AR) system, the method including creating a marketing campaign within the AR system, defining a set of rewards within the marketing campaign, the rewards selected for users that complete the marketing campaign; initiating an AR Reward Experience, and upon completion of the AR Reward Experience, awarding a reward from the set of rewards to a user that completes the marketing campaign, wherein the marketing campaign engages the user utilizing the AR system, thereby creating an effective marketing campaign.

In yet another embodiment, the present invention provides an Augmented Reality (AR) Reward Experience system, the system including An AR enabled device, A Decision Maker System, in communication with the AR enabled device, the Decision Maker System configured to create a Reward Campaign for at least one AR enabled device; and A Reward Platform, in communication with the Decision Maker System and the AR enabled device, for communicating a Reward to the AR enabled device, wherein the AR Reward Experience system provides an engaging augmented reality for allowing a user to recognize a virtual object overlayed in a physical location using their AR enabled device, for the purpose of earning a monetary reward.

### BRIEF DESCRIPTION OF THE DRAWINGS

FIG. 1 is an example block diagram of an AR Reward Experience system and method.

FIG. 2 is an illustration of an AR enabled device showing an initiation to the AR Reward Experience.

FIG. 3 is an illustration of the AR enabled device showing a permissions screen, if needed.

FIG. 4 is an illustration of the AR enabled device showing a pass-thru environment, on the devices screen.

FIG. 5 is an illustration of the AR enabled device showing the pass-thru environment, as well as an object to be found overlay.

FIG. 6 is an illustration of the AR enabled device showing the Reward won by a user after locating the object to be found.

FIG. 7 is an illustration of the AR enabled device showing the rewards that have been won by the user within the AR experience.

FIG. 8 is a flow chart illustrating the flow of the AR Reward Experience for a particular marketing campaign.

FIG. 9 is an illustration depicting the workflow for a post-transaction triggered AR Reward Experience.

FIG. 10 is an illustration depicting the function of how random object positioning occurs relative to the AR enabled device.

FIG. 11 is an illustration of how geo specific object positioning relative to the AR enabled device functions.

### DETAILED DESCRIPTION

Our invention is an augmented reality (AR) experience that can be customized, themed, and deployed for a given brand. The augmented reality experience is a discovery game where an end user examines their environment for a given item(s) (object-to-find) using a AR enabled device (currently through the camera of a mobile phone but also an AR headset as well). Upon recognizing the item they have been tasked to recognize, the end-user engages with the object-to-find by tapping on it through their phone screen (or looking at it through a headset). Each experience has 1 to n items that must be recognized (or identified). When all have been recognized, the end user is presented with a reward.

The object-to-find that the end-user must recognize is a 3d model or series of 3d models that can be either static or animated. The experience can be bound to a specific location, or a location that is relative to the end user. For example, if a coffee shop wanted their customers to only be able to engage with, and complete, the experience inside one of their physical store locations, the experience can be restricted to only work on-site. This is done using geographical coordinates and employing an appropriately sized geo-fence around the coordinate, designating the area in which the experience can operate. In one aspect of the invention, an AR object is provided that when recognized, produces monetary rewards tied to a specific physical location.

The object-to-find in AR space can be in a random position relative to the user operating the AR enabled device, it can be fixed to a specific location, or it can be in a location that is relative to a geo coordinate. Let's look at these cases individually:
1. **Random position:** when the end-user opens the AR experience, the invention makes a real-time decision about where to position the object-to-find. The object is configured at a set distance from the AR enabled device. The distance is a determination made ahead of time and is specifically chosen to make sure the object is at an appropriate size and is easily discoverable. The position of the object is then determined by moving the object a randomly determined number of degrees around a 360 degree arc using the AR enabled device as the center and the fixed distance as the radius. When positioning the object, exclusion zones may be pre-configured. An exclusion zone is a field-of-view (FOV) exclusion where the object will not show (e.g. don't show the object directly in front of the end-user when the experience is activated).
2. **Specific location:** in this configuration, the object-to-find is positioned at a specific geo-coordinate. In order to find and interact with the object, the end-user must be in the same physical location as the object. An example of this use case may be a large event (like SXSW or Coachella) where a brand might challenge end-users to find and collect a set number of objects throughout the event space in order to receive a specific reward. The AR enabled device must also be geo-location enabled such that the device location can be determined relevant to the object-to-find.
3. “Relative to a geo coordinate”-In this configuration, the object-to-find may be in a brick and mortar structure, or an otherwise geo specific area (e.g., a store, an outdoor tent area, etc.), but rather than utilizing GPS, the area may utilize Near Field Communications (NFC), WiFi triangulation technology, or physical positioning beacons within the area. That is, in one embodiment, the object-to-find may ‘hover’ over an area defined by the AR experience, once the end user enters the geo specific area. It should be appreciated by one skilled in the art that the methodology used to overlay the virtual object to find, within a physical space, should not be limited to existing communication protocols described herein, but should extend to emerging technologies for placement of virtual objects in a physical space. How the object is randomly positioned in proximity to the user in this use case isn't as critical as the idea that there is an object placed in a physical location that the user visits. When the user finds/sees that object, they receive a monetary reward.

The reward associated with the object-to-find is monetary, i.e., a discount, a promotion, a coupon, a physical item, a gift-card, or cash back. Depending on the campaign configuration, the reward can be either fixed or variable. In the fixed case, every end-user that engages with the associated AR campaign is going to find/receive the same reward. In the variable case, what the end-user receives can vary (e.g. every end-user at least finds a free donut but 1 end-user will receive a $5k grand Reward). Virtual items with a real world monetary value is a novel concept.

Configuring an AR campaign is done through a web-based campaign builder tool. In this tool, a marketer can build, customize, configure, and deploy an AR reward campaign using a point-and-click interface. Depending on the configuration, it is possible for a marketer to setup and launch a campaign without having to coordinate with engineering staff to build any functionality or do a code level integration. In other configurations, light code integration is required. That code integration is intentionally structured to require minimal lift from integrating partners.

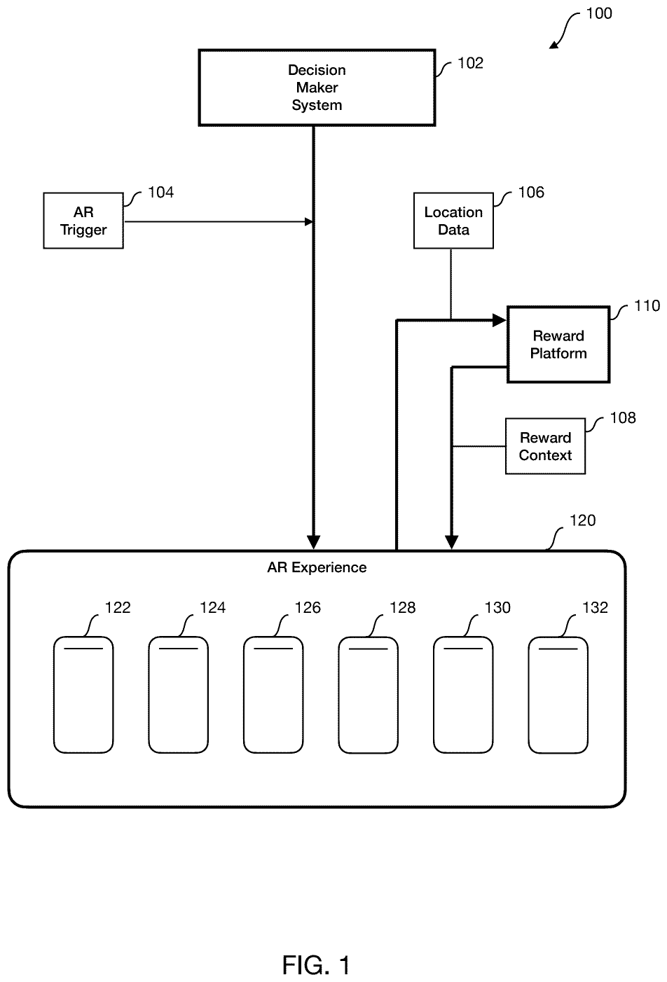

Referring to FIG. 1, a system diagram 100 is provided illustrating an end to end augmented reality (AR) reward experience. The experience starts with a decision maker system 102 determining that an end user should receive an AR rewards experience. The decision maker could be a company, an individual, or a piece of software. The decision-maker not only determines who will get the experience and win, it also determines which experience (campaign) the end user will be receiving. The decision maker system 102 can be a computer, a tablet, a phone, etc., in combination with the AR reward software further described below. In one embodiment, the decision maker system 102 includes a web hosted server, and software for configuring campaigns for the AR experience system.

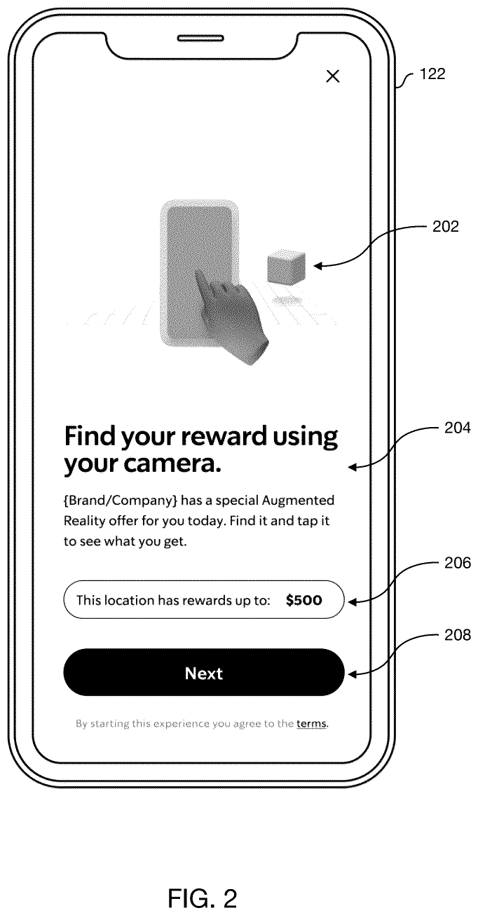

An AR Trigger 104 is shown coupled to the Decision Maker System 102 for sending an AR Trigger to an AR Experience 120. The AR Experience 120 includes one or more user devices 122-132. For purposes of FIG. 1, the AR Experience 120 is illustrated with a single device 122, that has multiple states during the AR Experience, as will be further described below with reference to FIGS. 2-7. The AR Trigger 104 is a signal sent from the decision maker system 102 to an AR enabled device 122 notifying the device of the eligibility to participate in the AR Experience 120. In one embodiment, the AR Trigger 104 is an instruction sent to an AR enabled device 122 over a telecommunications network. Alternatively, the instruction may be sent to an AR enabled device via a wifi network.

In one embodiment, the user device 122 that runs the AR experience is a smart phone, a tablet, a headset, or other AR enabled hardware. In the case of geo restricted or geo activated campaigns, the AR enabled device 122 communicates geo location data 106 to a reward platform 110 to confirm eligibility for the respective campaign. The Reward Platform 110 contains the knowledge and configuration information for the campaign that is being triggered. The Reward Platform 110 looks up the campaign, confirms eligibility, and makes a real-time decision about the reward that will be awarded for this instance of the AR Experience. The Reward Platform further communicates the reward information back to the AR enabled device 122.

A Reward Context 108 contains confirmation of eligibility. If eligible, it also contains the needed information to execute the experience on the AR enabled device 122. That information includes: theming context (i.e., how the experience should look for this campaign), 3D model to be used, and reward determination (what reward is the end user going to be looking for).

After receiving the reward context, the AR enabled device 122 presents a prompt to begin the reward.

Referring to FIG. 2, the AR enabled device 122 is shown. As mentioned above, the AR enabled device 122 could be a smart phone, a tablet, a headset, or other AR enabled hardware. More specifically, the AR enabled device 122 has received an AR Trigger 104 signal. The screen in FIG. 2 shows context on how to participate and also covers needed device permissions if applicable (e.g., camera and location). In one embodiment, an illustration of the object to be found is shown as object 202 on the screen of the AR enabled device 122. And, in addition to providing a visual illustration of an object 202, help text 204 may also be provided to inform the user of how to participate in the AR Experience. Alternatively, a visual tutorial 202 can be shown illustrating how the end user will participate and complete the AR experience. Furthermore, an indication of a Reward 206 is shown to encourage the user to continue with the AR experience. Finally, a Next button 208 is provided to advance the user to the next step in the AR experience. What should be appreciated by one skilled in the art is the concept of putting a virtual object in augmented space that, when interacted with, provides the user a monetary reward. The exact implementation of this idea may be accomplished in a variety of ways, without departing from the scope of the invention.

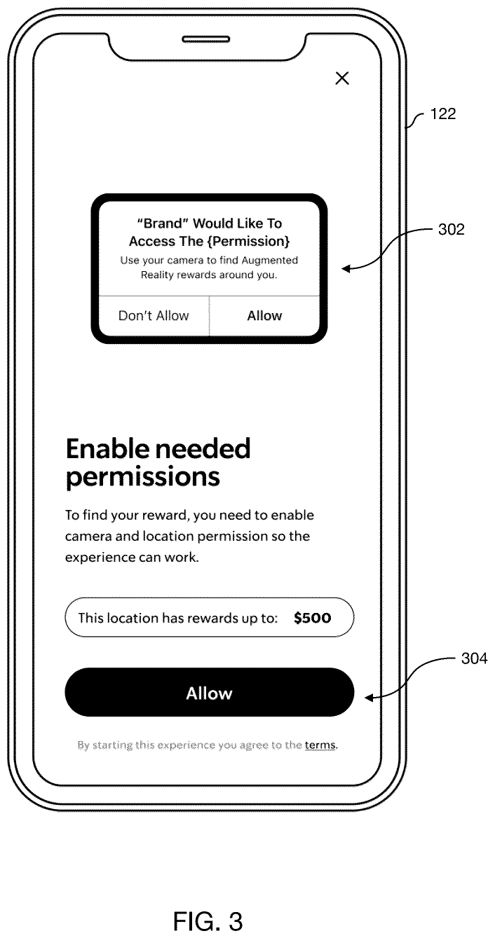

Referring to FIG. 3, the AR enabled device 122 is shown. The screen on the AR enabled device 122 follows after selection of the Next button 208 from FIG. 2. More specifically, if the AR enabled device 122 has not yet had an AR experience, a permissions dialogue box 302 is provided. The box allows the user to either Allow, or Don't Allow, the AR experience that has been triggered. If the user wishes to engage in the AR experience, the user selects an Allow button 304 on the AR enabled device 122. Permission access isn't always required. Permissions depend on the delivery medium (native vs web) and the AR enabled device 122.

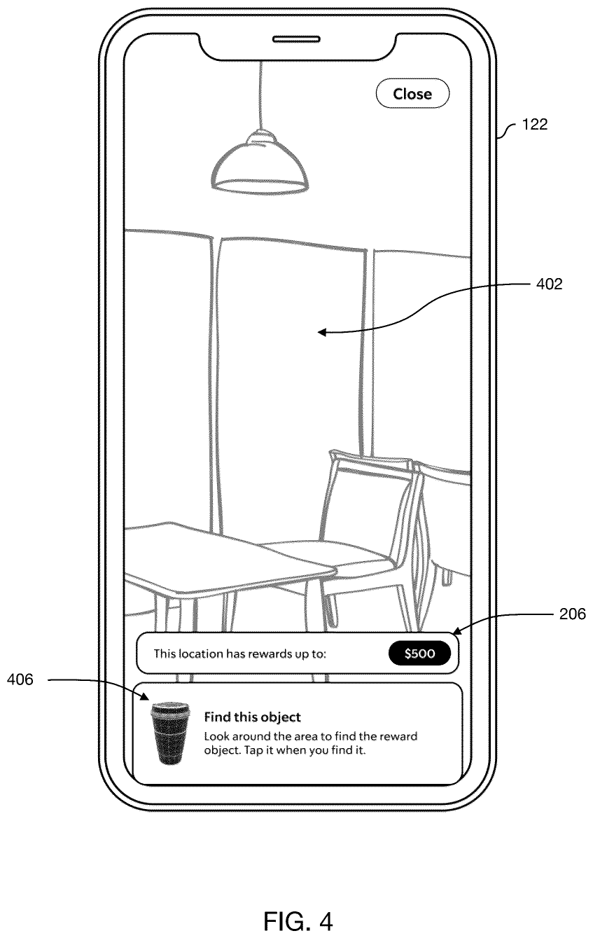

Referring to FIG. 4, the AR enabled device 122 is shown. The screen on the AR enabled device 122 follows after AR permissions are allowed (in FIG. 3). More specifically, the AR enabled device 122 shows the user a pass-through view 402 of the physical world around them-meaning the user will look through the device 122 and see an augmented version of the real world in front of their AR enabled device 122. Once in this view, the user will be prompted to look around and find a specific object-to-find. In addition to the pass-through view 402, the reward 206 is illustrated at the bottom to remind the user of the potential reward if they find the designated object. Also included on the screen of the AR enabled device 122 is an illustration of the object 406. This allows the user to have a visual representation of the object 406 located somewhere around them.

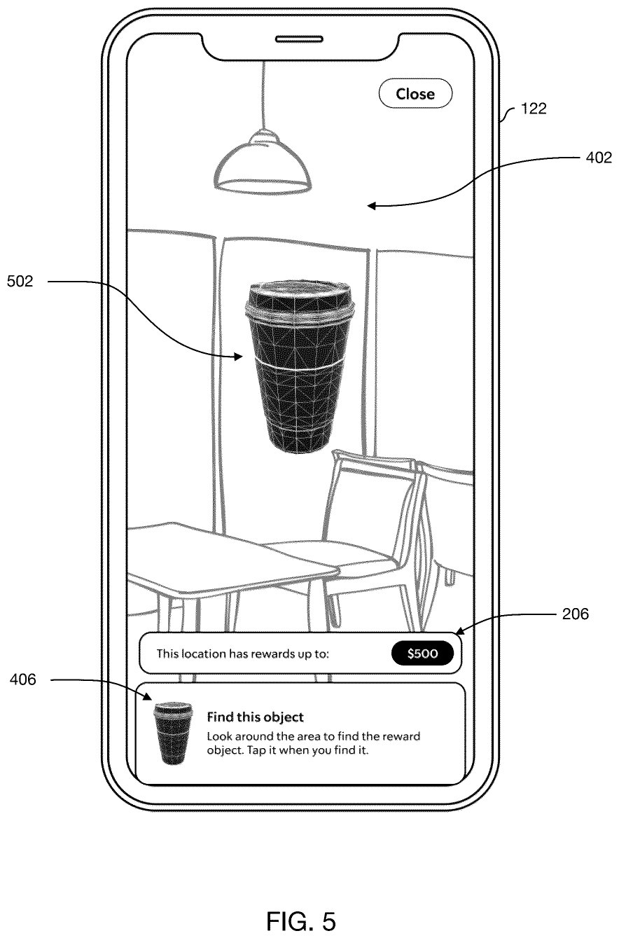

Referring to FIG. 5, the AR enabled device 122 is shown. The screen on the AR enabled device 122 still has the reward reminder 206, as well as the illustration of the object 406 that is to be located. In addition, within the pass thru screen 402 is a ‘virtual’ object 502. This is the object that the user is to find, as it is identical to the prompt 406. As the user looks around their physical environment (thru the AR enabled device 122), they will eventually discover the object to find positioned within or floating around the environment. Eventually, the user has located the object within the AR view 402 on the AR enabled device 122. At this point, the user taps (if the AR enabled device 122 is a phone or tablet), or gestures/looks at (in the case of a headset or other AR enabled device) the object to open it and receive the reward it represents. One skilled in the art will appreciate that alternatives methods may be used to indicate that the object has been found within the pass thru screen 402, whether such indication includes haptics, prompts, or software means which accurately concludes that the desired object 502 is within the pass thru screen 402, and has been recognized by the user. This invention should not be restricted to the methodology used to detect whether the user becomes aware of the ‘virtual’ location of the object 502 within the pass-thru screen 402.

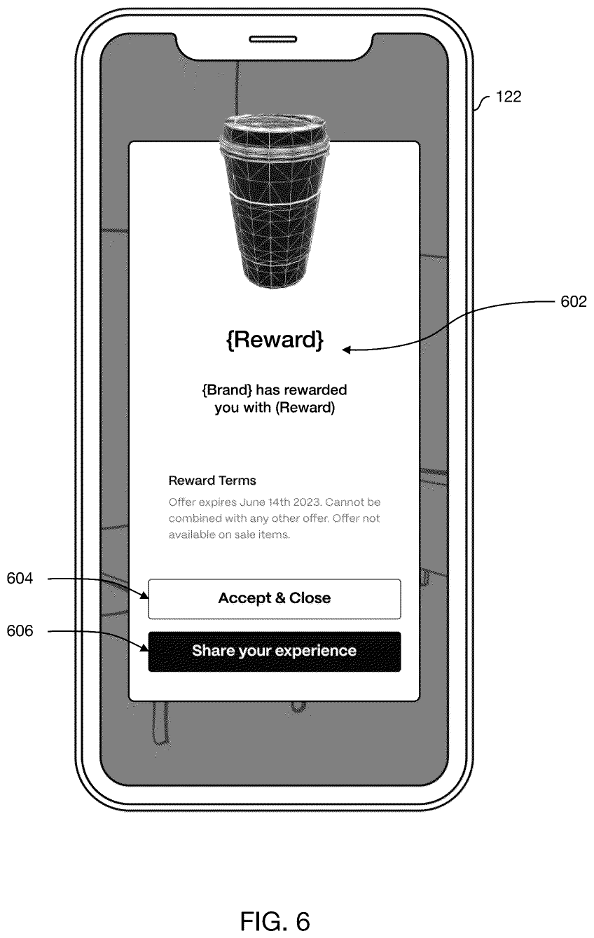

Referring to FIG. 6, once the AR enabled device 122 determines that the user has located the object to be found, the screen advances to what is shown in FIG. 6. At this point, the user is shown what Reward 602 they have one for locating the ‘virtual’ object. Examples of such Rewards could be monetary (e.g., $10), a discount, a promotion, a coupon, or physical items (e.g., a free latte, a gift card, or cash back), or points. Once the Reward 602 is indicated, the user can accept the Reward by pushing button 604, and/or share their AR reward experience with others by selecting button 606. The Reward is then placed into an account for the Brand that initiated the AR campaign. In one embodiment, acceptance of the Reward is not dependent on the press of the button 604. As soon as the user interacts with the object to find, the reward is associated with the user.

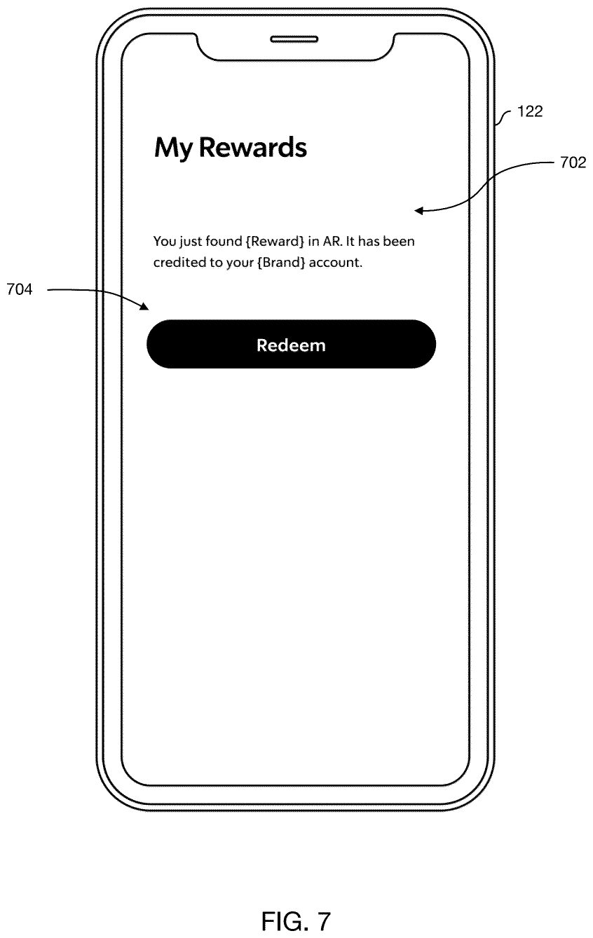

Referring to FIG. 7, the AR enabled device 122 is shown with a screen 702 that lists the Reward(s) that the user has won, within the AR experience. The user can choose to simply accumulate the rewards, or redeem any of the rewards, by selecting the Redeem button 704.

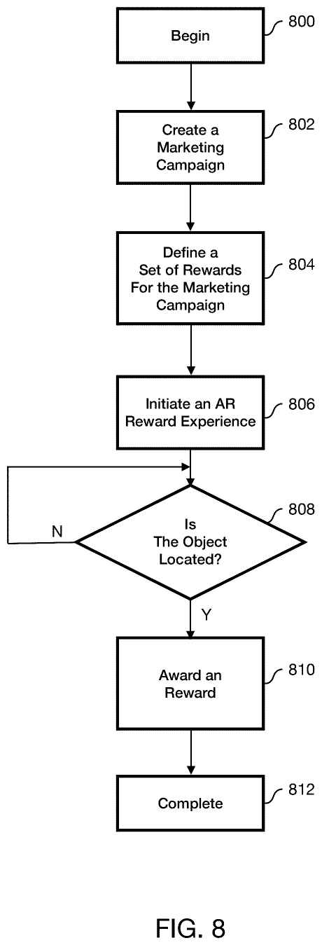

Referring to FIG. 8, a flow chart illustrating the method of the AR Reward Experience is shown. The experience begins at step 800 and flows to step 802. At step 802, a marketing campaign is created. A marketing campaign includes an AR Reward Experience utilizing an AR enabled devices such as a cell phone, tablet, watch, goggles, etc., as explained above. The marketing campaign operates via an application on such devices, or a web application operating on the devices. The marketing campaign creates objects that are recognizable within the view 402 described with reference to FIG. 5 and designates which of the created objects 502 will be shown within the view 402. The marketing campaign further defines the location of the objects 502. The location of the objects 502 may be placed either in a specific geo location, or alternatively, in a location relative to the geo location of the user (e.g., 5 feet away, 310 degrees, etc.).

Referring to step 804, a Set of Rewards for the Marketing Campaign are defined. The marketing campaign includes a number of possible rewards (i.e., % discounts, product giveaways, cash back bonuses) and designates one of the possible rewards for each AR Reward Experience. In one embodiment, the reward is chosen at the beginning of the AR Reward Experience. However, an alternative embodiment selects a Reward upon completion of the Reward Experience. The present invention should not be limited to the timing, or methodology used in selecting the Reward for a particular AR Reward Experience. What should be appreciated at this stage is that the AR Reward Experience is typically created by a business, or other retail entity that is wanting to attract consumers in an engaging way. It is the end user, or consumer that will have the AR Reward Experience that has been designed by a business or retail entity. Flow proceeds to step 806.

At step 806, the AR Reward Experience is initiated. Such initiation results in presenting the view shown with reference to FIG. 4. A thru screen view 402 is provided. Flow proceeds to step 808.

At step 808, the thru screen 402 continues to update based on where the AR enabled device 122 is pointing. As the user points the AR enabled device 122 to different areas within their location, the selected object 502 (of FIG. 5) will eventually show itself. The thru screen 402 continues to show a representation of the location until the selected object 502 appears. Once it is determined that the selected object 502 has been found, flow proceeds to step 810.

At step 810, a Reward that has been designated for the AR Reward Experience is presented to the user. The user can either redeem the reward, or save the reward for later redemption. Flow then proceeds to step 812 where the AR Reward Experience is completed.

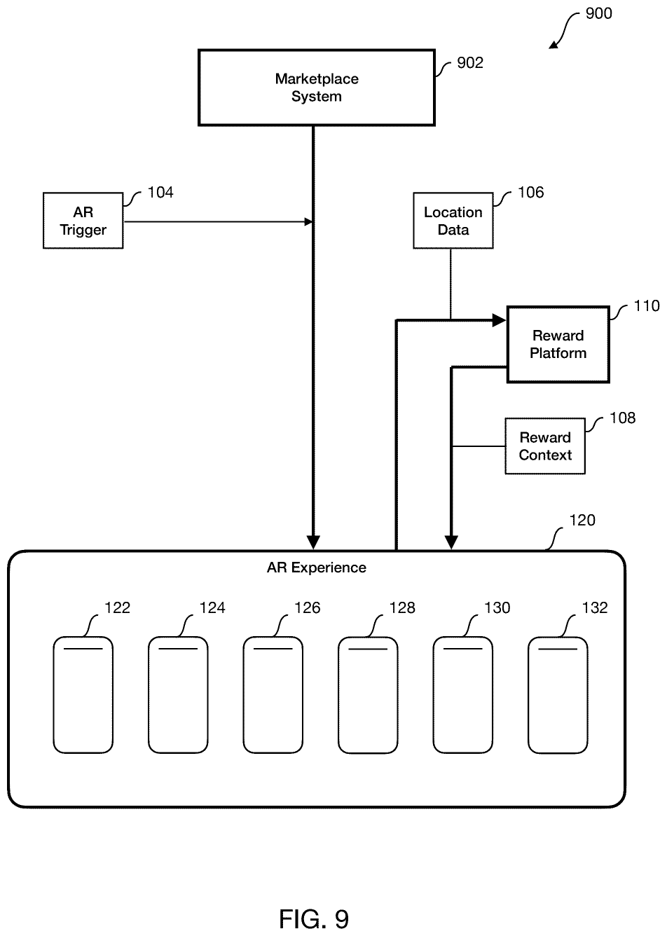

Referring now to FIG. 9, a variation of the invention illustrated in FIG. 1 is provided illustrating the workflow 900 for a post-transaction use case. In FIG. 9, the decision maker 102 is replaced by a marketplace system 902 that processes financial transactions. A qualifying transaction triggers the AR Reward Experience that is provided to the end user that just completed a transaction. Flow then proceeds as described above with respect to FIG. 1.

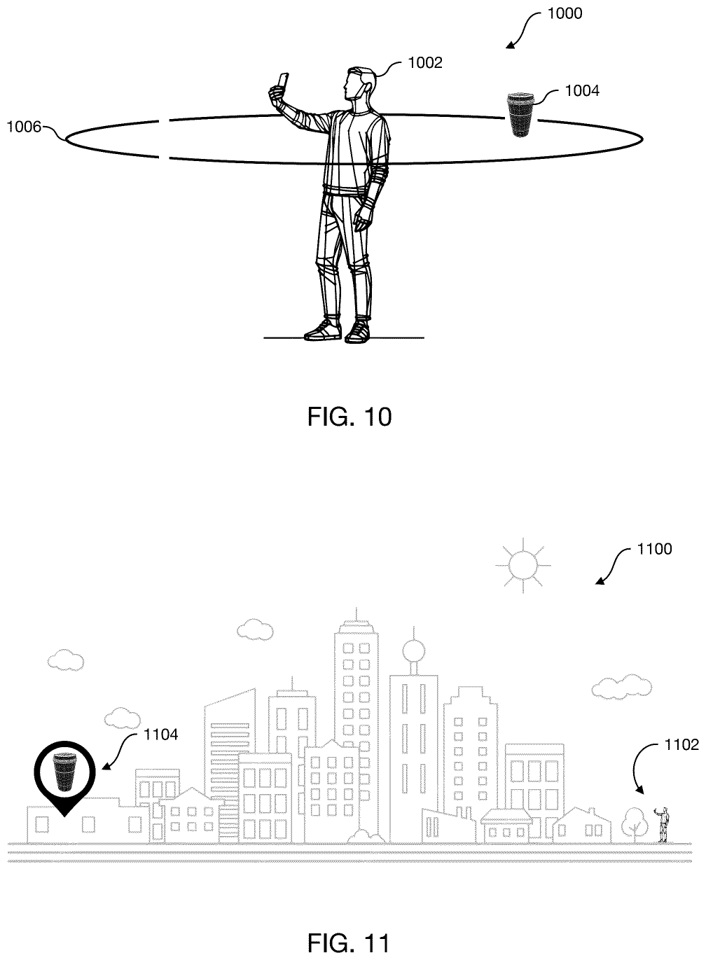

Referring to FIG. 10, an eligible end user 1002 is shown engaging in the AR Reward Experience. Upon entering the experience, the position of the object to find 1004 is randomly determined using a set of defined rules. In a defined rule set, there may be exclusion zones 1006 defined. Illustration 1000 shows a frontal exclusion zone 1006 of 70 degrees. This means that the object to find 1004 will not appear within 35 degrees to either the left or right of the center of the end users1002 field of view when they enter the AR Reward Experience. Rather, the object 1004 is positioned randomly along a 360 degree arc, with the exception of the exclusion zone 1006 that is a fixed distance away from the end user 1002. In an alternative embodiment, there may be more than one exclusion zone 1006. One skilled in the art will appreciate that whether or not an exclusion zone 1006 is used, and the location/dimensions of the exclusion zone, can vary from one AR Reward Experience to another. It is up to the company owner, or retail space, to define the parameters of an exclusion zone 1006, as desired.

Referring to FIG. 11, a depiction 1100 is shown of how geo specific object positioning relative to the AR enabled device functions. More specifically, an eligible end user 1102 engages in the AR Reward Experience. Upon looking for the object to find 1104, the end user 1102 may or may not see the item based on their physical location. If they are too far away from the object, it will not be visible. The object to find 1104 shown is positioned at a specific location (geo coordinate). In one embodiment, the end user 1102 may be prompted with hints to help locate the specific location.

What has been described above, and in the drawings and appended claims, is a method and apparatus for providing an end user with an engaging and rewarding Augmented Reality (AR) experience designed to both entertain and reward the end user in a particular product or market.

It should be understood—especially by those having ordinary skill in the art with the benefit of this disclosure—that the various operations described herein, particularly in connection with the figures, may be implemented by other hardware components utilizing telecommunications, whether towers, satellites, or wifi. Additionally, the order in which each operation of a given method is performed may be changed, unless otherwise indicated, and various elements of the systems illustrated herein may be added, reordered, combined, omitted, modified, etc. It is intended that this disclosure embrace all such modifications and changes, and, accordingly, the above description should be regarded in an illustrative rather than a restrictive sense.

Similarly, although this disclosure refers to specific embodiments, certain modifications and changes can be made to those embodiments without departing from the scope and coverage of this disclosure. Moreover, any benefits, advantages, or solutions to problems that are described herein with regard to specific embodiments are not intended to be construed as a critical, required, or essential feature or element.

Further embodiments, likewise, with the benefit of this disclosure, will be apparent to those having ordinary skill in the art, and such embodiments should be deemed as being encompassed herein. All examples and conditional language recited herein are intended for pedagogical objects to aid the reader in understanding the disclosure and the concepts contributed by the inventor to furthering the art and are construed as being without limitation to such specifically recited examples and conditions.

1. An Augmented Reality (AR) Reward Experience system, comprising:
An AR enabled device;
A Decision Maker System, in communication with the AR enabled device, the Decision Maker System configured to create a Reward Campaign for at least one AR enabled device;
An AR Trigger, in communication with the AR enabled device, for initiating an AR Reward Experience after the Reward Campaign is created; and
A Reward Platform, in communication with the Decision Maker System and the AR enabled device, for communicating a Reward to the AR enabled device;
wherein the AR Reward Experience system provides an engaging augmented reality for allowing a user to recognize a virtual object using their AR enabled device, for the purpose of earning a reward.

2. The AR Reward Experience system of claim 1, wherein the AR enabled device comprises:
a cell phone;
a tablet; or
AR goggles.

3. The AR Reward Experience system of claim 1 wherein the Decision Maker System comprises:
A web hosting platform, the platform coupled to the internet;
First Software, executing on the web hosting platform, for configuring the AR Reward Experience; and
Second Software, for providing the AR Reward Experience to AR enabled devices.

4. The AR Reward Experience system of claim 3 wherein the Second Software comprises an application on an AR enabled device.

5. The AR Reward Experience system of claim 3 further comprising:
A Reward Platform, coupled to the Decision Maker System, for creating rewards for the AR Reward Experience.

6. The AR Reward Experience system of claim 4, wherein the Reward Platform comprises:
An interface for creating a plurality of Rewards for a particular campaign; and
A database for storing each of the plurality of Rewards for the particular campaign.

7. The AR Reward Experience system of claim 5 wherein the Reward Platform further comprises:
A Rewards selector, for selecting one of the plurality of Rewards for each instance of a user AR Experience.

8. The AR Reward Experience system of claim 6 wherein one of the plurality of Rewards comprises a discount off a purchase.

9. The AR Reward Experience system of claim 6 wherein one of the plurality of Rewards comprises a free product sold from the store that created the campaign.

10. A Marketplace system for triggering an AR enabled device, comprising:
An AR Trigger, for triggering an AR enabled device after and end user of the AR enabled device completes a commercial transaction;
The AR enabled device, for receiving the trigger; and
Software, executing on the AR enabled device, for launching an AR Reward Experience, wherein the software:
Provides a thru view of the world in front of the AR enabled device;
presents a selected object to the end user when the AR enabled device is pointed at a preselected virtual position relative to the end user; and
Presents a Reward to the end user when the end user locates the selected object within the thru view;
Wherein the end user is engaged in the AR Reward Experience after completing the commercial transaction.

11. A marketing method for engaging a user in a marketing campaign, the marketing campaign utilizing an Augmented Reality (AR) system, the method comprising:
Creating a marketing campaign within the AR system;
Defining a set of rewards within the marketing campaign, the rewards selected for users that complete the marketing campaign;
Initiating an AR Reward Experience; and
Upon completion of the AR Reward Experience, awarding a reward from the set of rewards to an end user that completes the marketing campaign;
Wherein the marketing campaign engages the end user utilizing the AR system, thereby creating an effective marketing campaign.

12. The marketing method as recited in claim 11 wherein the step of creating comprises:
Creating a plurality of objects to be utilized within the AR Reward Experience, the objects selected for display overlays on a thru screen to an AR enabled device; and
Defining a location for the display overlays that are relative to the AR enabled device for display on the thru screen of the AR enabled device.

1. The marketing method as recited in claim 12 wherein the step of defining a location for the display overlays, places the display overlays in a specific geo location, for identifying on the thru screen of the AR enabled device.

13. The marketing method as recited in claim 11 wherein the step of defining comprises establishing a percentage discount to be applied on a purchase.

14. The marketing method as recited in claim 11 wherein the step of defining comprises establishing a percentage discount to be applied to a purchase of a pre selected item.

15. The marketing method of claim 11 wherein the step of defining comprises establishing a gift for the end user.

16. The marketing method as recited in claim 11 wherein the step of Initiating an AR Reward Experience comprises:
Sending a trigger to an AR enabled device;
Specifying a selected object to be shown to the end user; and
Specifying a reward to be provided when the end user locates the selected object on the AR enabled device.

17. The marketing method as recited in claim 17 wherein the step of awarding, awards the end user the specified reward.

18. An Augmented Reality (AR) Reward Experience system, comprising:
An AR enabled device;
A Decision Maker System, in communication with the AR enabled device, the Decision Maker System configured to create a Reward Campaign for at least one AR enabled device; and
A Reward Platform, in communication with the Decision Maker System and the AR enabled device, for communicating a Reward to the AR enabled device;
wherein the AR Reward Experience system provides an engaging augmented reality for allowing a user to recognize a virtual object overlayed in a physical location using their AR enabled device, for the purpose of earning a monetary reward.
